(19) United States
(12) Patent Application Publication
(10) Pub. No.: US 2004/0100501 A1
(43) Pub. Date: May 27, 2004

(54) Method of dragging and dropping defined objects to or from a web page

(76) Inventor: Jason Robert Dornback, Carrollton, TX (US)

Correspondence Address: Jason Dornback, 2116 Sonata Lane, Carrollton, TX, 75007, US

(21) Appl. No.: 10/303,139

(22) Filed: Nov. 25, 2002

(51) Int. Cl. G09G 5/00

(52) U.S. Cl. 345/769

(57) ABSTRACT

The invention relates generally web pages, and more particularly to an innovative method and system for allowing users to take defined content and drag and drop that content to or from a location off of the web page. It also allows users to drag defined content from a web page to the users desktop, or from the users desktop to a web page. The dragged object can be any portion of the web page code (text, hyperlinks, forms, images, tables, Java Applets, Java Script, Flash content, Shockwave content, video content or other web page components).

### RELATED PATENTS

“The method of dragging and dropping defined objects to or from a web page.” Initial previous provisional filing receipt: Jc973 U.S. PTO 60/350001 Jan. 23, 2002

“Method to customize the appearance of a web page by dragging and dropping objects within a page.” Utility filing receipt: Jc872 U.S. PTO 09/955449 Sept. 19, 2001

### FIELD OF THE INVENTION

The present invention relates generally web pages, and more particularly to an innovative method and system for allowing users to take defined objects and drag and drop those objects to or from a web page. This invention enables users to drag and drop portions of a web page to a different web page, to or from the users desktop, or to or from other software applications.

### BACKGROUND OF THE INVENTION

The Internet is a worldwide system of computer networks—a network of networks in which users at any one computer can, if is has permission, get information from any other computer. Intranets are similar services that are available on private local area networks (LANs). The World Wide Web (WWW) and similar private architectures provide a “web” of interconnected documents, called “web pages” on intranets and the Internet.

Web pages are typically made up of HyperText Markup Language (HTML) tags displaying HTML source files containing the headings, data, text, footings and hyperlinks to other web pages. An HTML document includes a hierarchical set of markup elements; most elements have a start tag, followed by content, followed by an end tag. The content is a combination of text and nested markup tags. HTML tags, which are enclosed in angle brackets (‘<’ and ‘>’), indicate how the document is structured and how to display the document, as well as destinations and labels for hypertext links. There are tags for markup elements such as titles and headers, text attributes such as bold, italic, lists, paragraph boundaries, links to other documents or other parts of the same document, inline graphic images, and for many other features. JavaScript provides a way to include programs, which are downloaded in a Web page, enabling the user to change some page properties. More information about JavaScript and the Java programming language may be found in Java in a Nutshell by David Flanagan, published by O'Reilly & Associates, Copyright 1996.

Web server software languages such as Active Server Pages (ASP), Java Server Pages (JSP), or ColdFusion are software languages that are executed on the web server. They provide a method for determining what content to serve to the client computer. These languages also provide interfaces to the web server resources, such as files or databases stored on the server. Such software languages also provide methods of sending, retrieving, and processing information sent to and from web pages.

### SUMMARY OF THE INVENTION

This invention enables users to drag and drop objects to or from a web page, the users desktop, or other software applications. The dragged object can be any portion of web page code such as text, hyperlinks, forms, images, tables, Java Applets, Java Script, Flash content, Shockwave content, video content or other web page components. Objects dropped from the web page retain the functionality from the original web page.

### BRIEF DESCRIPTION OF THE DRAWINGS

FIG. 1 Example of dragging an object from one web page to another; the web pages prior to dragging object.

FIG. 2 Example of dragging an object from one web page to another; the same web pages after dragging the object.

FIG. 3 Example of dragging an object from a web page to the desktop; the web page and desktop prior to dragging the object.

FIG. 4 Example of dragging an object from a web page to the desktop; the web page and desktop after dragging the object.

FIG. 5 Example of dragging an object from a web page to a word processor; the web page and word processor before dragging the object.

FIG. 6 Example of dragging an object from a web page to a word processor; the web page and word processor after dragging the object.

### DETAILED DESCRIPTION OF THE INVENTION

This invention enables users to drag and drop portions of a web page to or from a different web page, to the users desktop, or to other software applications. The dragged object can be any portion of the web page code such as text, hyperlinks, forms, images, tables, Java Applets, Java Script, Flash content, Shockwave content, video content or other web page components. The objects dropped to or from the web page retain the functionality from the original web page.

The invention relates generally web pages, and more particularly to an innovative method and system for allowing users to take defined content and drag and drop that content to or from a location off of that web page. This invention enables users to create a customized site by dragging web page content from multiple different web sites in different browser windows to a different web site. It also allows users to drag defined content from a web page to the users desktop, or from the users desktop to a web page. The dragged object can be any portion of the web page code (text, hyperlinks, forms, images, tables, Java Applets, Java Script, Flash content, Shockwave content, video content or other web page components).

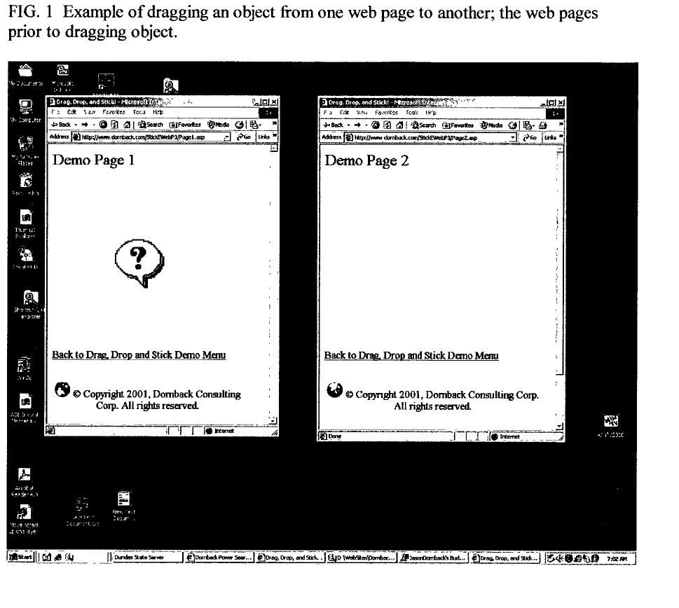

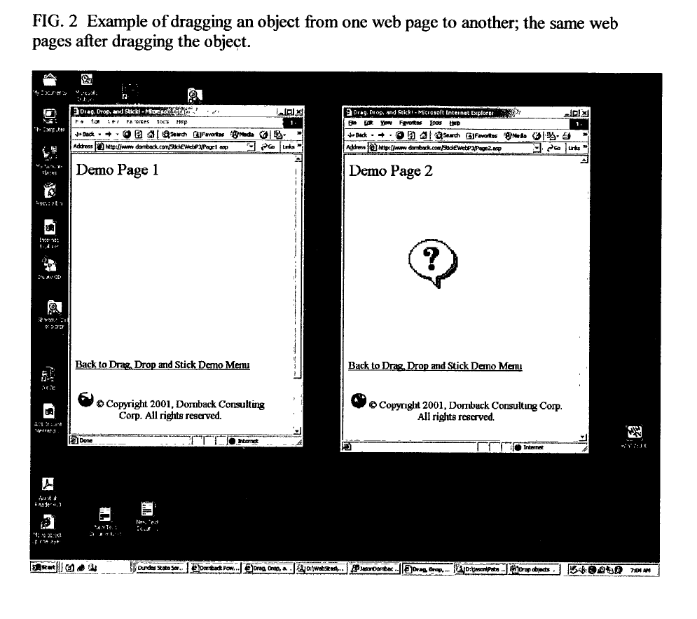

This invention allows users to drag defined objects from one web page to a different web page. The second web page can be in a frame within the same browser, or in a completely separate browser window. FIGS. 1 and 2 demonstrate dragging an object from one web page to a different web page in a different browser. FIG. 1 shows the web pages prior to the object being dragged. FIG. 2 shows the web pages after the object is dragged from the first browser to the second browser. The dragged object is moved from the original web page to the destination web page. This functionality could be implemented by defining objects within a web page that can be dragged to other locations, and with a browser plugin that recognizes objects dropped from other browsers or applications. It could also be accomplished with changes to the web page browsers so that the browser recognizes the dragged and dropped objects to and from other applications. The web page designer can define which objects on the web page are able to be dragged, and which objects cannot be dragged by the user. The functionality of the web page object code is retained in the new browser. FIGS. 1 and 2 demonstrate an object being moved from one web page to another. The object in the original web page is removed and displayed in the new web page. The object could also be copied from one web page to another, in which case, the object would be displayed in both the original web page, and the destination web page.

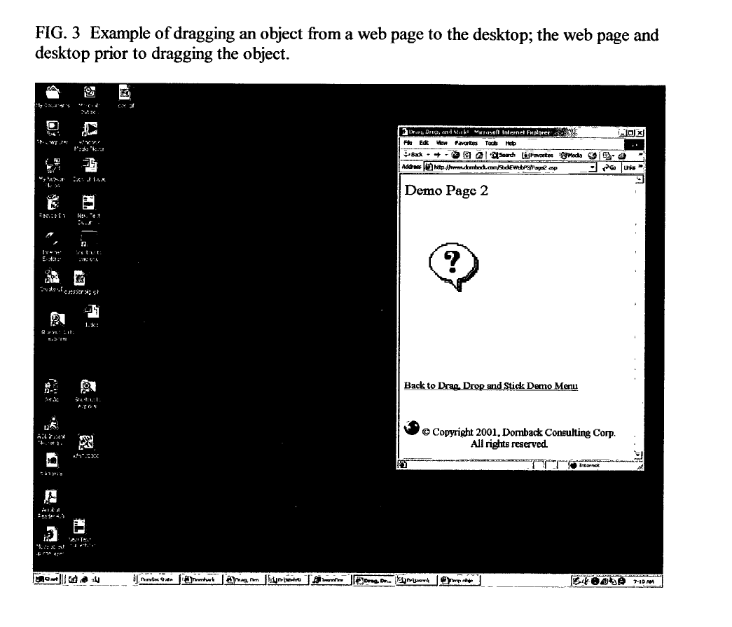

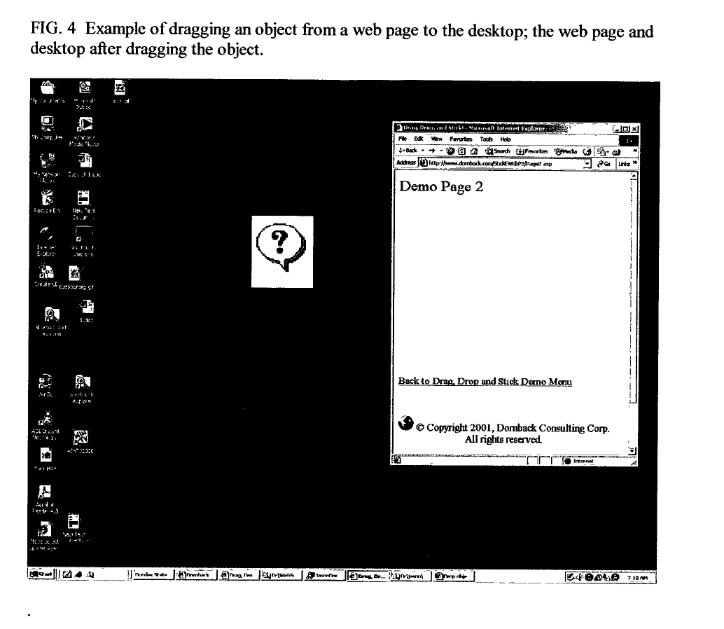

FIGS. 3 and 4 demonstrate the ability to drag an object from a web page to the users computer desktop. FIG. 3 displays the web page and the user desktop prior to dragging the object, The object is displayed in the browser. After the user drags the object from the web page to the desktop, the object is displayed on the users desktop as shown in FIG. 4. Users can currently define web content to be displayed on the users desktop using the “Active Desktop” feature. This invention allows users to easily further utilize the Active Desktop by dragging defined web content objects from a web page to the users desktop, or from the desktop to a web page. As with dragging from one web page to another, the object could be moved or copied.

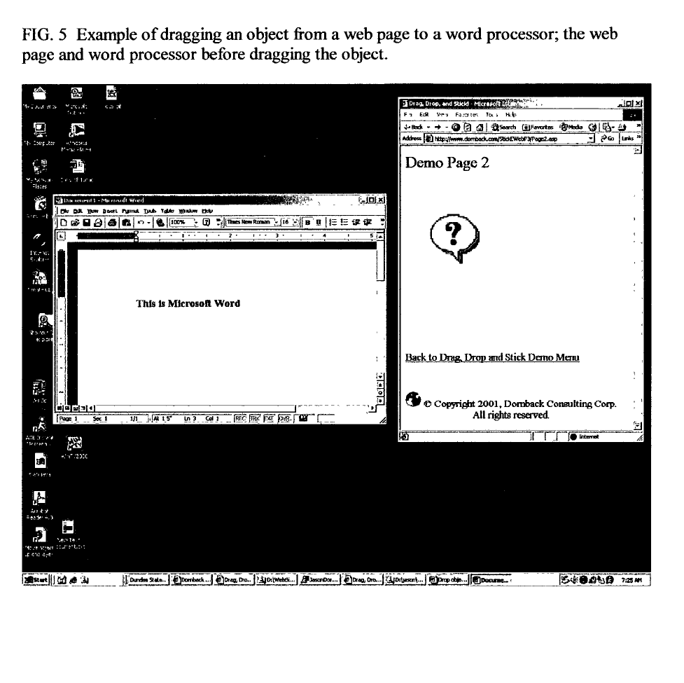

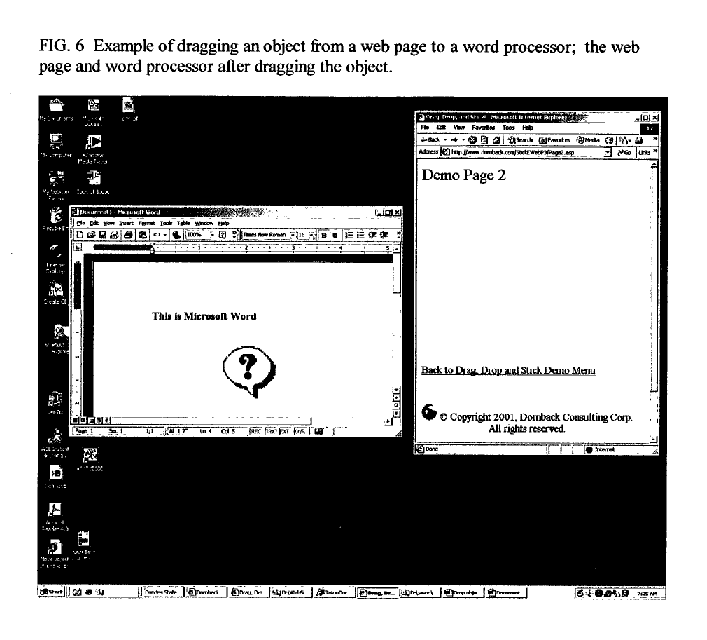

This invention also allows the users to drag an object from a web page to or from an application installed on the users computer. The application could be a word processor, spreadsheet, presentation software, email, or other software applications. FIGS. 5 and 6 demonstrate dragging an object from a web page to a word processor. FIG. 5 displays the web page and word processor prior to dragging the object. After the object is dropped, it is displayed in the word processor as shown in FIG. 6.

In one embodiment, this invention enables users to create a customized web site by dragging web page content from multiple different web sites in different browser windows to the customized user web site. Each different web site would have specific content defined as draggable to other sites. The receiving web site would recognize the Title of Invention: The method of dragging and dropping defined objects to or from a web page. dropped content. This allows the user to easily create a customized web site with specific content from multiple sites.

The receiving web site would also recognize objects dragged from the users desktop or software applications. For example, the user could drag text from a word processor to the web site. The text content would be displayed automatically on the receiving web site. Images could be dragged from photo editing software and dropped onto a specific location on a web page. The image would be uploaded to the web server, and automatically added to the web page at the location it was dropped.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. It is therefore intended that the following appended claims be interpreted as including all such alterations, permutations, and equivalents as fall within the spirit and scope of the present invention.

What is claimed is:

1. A method for enabling a user to drag a defined object from a web page to a different web page in a different browser window.

2. A method for enabling a user to drag a defined object from a web page frame to a different web page frame within the same browser window.

3. A method for enabling a user to drag a defined object from a web page to the users desktop.

4. A method for enabling a user to drag a defined object from a users computer desktop to a web page.

5. A method for enabling a user to drag a defined object from a web page to a software application on the users desktop.

6. A method for enabling a user to drag a defined object from a software application on the users desktop to a web page.

7. The method of claims 5 and 6, further comprising the software application may be any user application, such as a word processor, spreadsheet, presentation software, email program, or other software applications.

8. The method of claims 1 through 6, further comprising the objects that can be dragged may be collections of web page code, text, images, or data from software applications including but not limited to:
(a) HTML Formatted text
(b) Images
(c) Hyperlinks
(d) Forms
(e) Tables
(f) Java Applets
(g) Java Script
(h) Flash content
(i) Shockwave content
(j) Video content

9. The method of claims 1 through 6, further comprising the functionality of web page code within the draggable components are not affected by the ability to drag and drop the objects.

10. The method of claims 1 through 6, further comprising the objects that can be dragged may be dynamically updated content from other web pages. Examples include, but are not limited to:
(a) Stock reports
(b) News reports
(c) Weather reports
(d) Sports reports
(e) Financial information
(f) Television listings

11. The method of claim 10, further comprising that if the source object data is dynamically updated, the object will continue to be updated after it is dropped to the new location.

12. The method of claims 1 through 6, further comprising a method to rearrange the objects after dropped.

13. The method of claims 1 through 6, further comprising a method to delete the objects after dropped.

14. The method of claims 1 through 6, further comprising a method to recognize the source application of the object.

15. The method of claims 1 through 6, further comprising a method to recognize the destination application of the object.

16. The method of claims 1 through 6, further comprising the object can be moved from the source application to the destination so that the object is no longer displayed in the source application, or copied so that the object is displayed in both the source application and the destination application.

17. The method of claims 1 through 6, further comprising that if the object is dragged to and from different software applications, the object may be translated to a format that is recognized by the destination application in order for the object to be displayed and function correctly.
